(19) United States
(12) Patent Application Publication
(10) Pub. No.: US 2026/0111596 A1
(43) Pub. Date: Apr. 23, 2026

(54) Visual Treatment of User Representation When Interacting with Secure UI Element

(71) Applicant: Apple Inc., Cupertino, CA (US)

(72) Inventors: Sebastian P. Herscher, San Francisco, CA (US); Yeunju A. Kim, Mountain View, CA (US); Hayden J. Barsotti, Mountain View, CA (US); Madeline Zupan, Los Angeles, CA (US)

(21) Appl. No.: 19/347,009

(22) Filed: Oct. 1, 2025

Related U.S. Application Data
(60) Provisional application No. 63/709,322, filed on Oct. 18, 2024.
(60) Provisional application No. 63/766,747, filed on Mar. 4, 2025.

(51) Int. Cl. G06F 21/62; G06F 3/01; G06T 19/00

(52) U.S. Cl. CPC G06F 21/6245; G06F 3/013; G06T 19/006; G06T 2200/24; G06T 2219/024

(57) ABSTRACT

Security of user input is enhanced by opportunistically adjusting transmission of virtual representation data of a user in a copresence session. A sensitive input trigger is detected when an input component is detected that is capable of being used to provide user input of a sensitive input classification. In response to the trigger, the transmission of virtual representation data for the user is modified. The local device suspends transmission of the virtual representation data such that other devices in the copresence session do not receive information regarding the movements of the user while the input component is active. The local device can cease capture of tracking data by turning off a camera capturing user motion while the input component is active.

### BACKGROUND

Some devices can generate and present Extended Reality (XR) Environments. An XR environment may include a wholly or partially simulated environment that people sense and/or interact with by way of an electronic system. In XR, a subset of a person's physical motions, or representations thereof, are tracked, and in response, one or more characteristics of one or more virtual objects simulated in the XR environment are adjusted in a manner that comports with realistic properties.

Some XR environments allow multiple users to interact with virtual objects or with each other within the XR environment. For example, users may use gestures to interact with user input components of the XR environment. In addition, some XR environments allow for multiple users to interact with each other within a shared XR environment. However, what is needed is an improved technique for managing user input in a shared XR environment.

### BRIEF DESCRIPTION OF THE DRAWINGS

FIG. 1 shows, in flow diagram form, a technique for adjusting transmission of virtual representation data, according to one or more embodiments.

FIG. 2 shows a diagram of example presentation of a virtual representation of a user, according to one or more embodiments.

FIG. 3 shows a flowchart of a method for managing virtual representation data in accordance with sensitive user input components, in accordance with one or more embodiments.

FIG. 4 shows a diagram of example presentation of a modified live frame of a virtual representation of a user, according to one or more embodiments.

FIG. 5 shows a flowchart of a method for generating a modified live frame of virtual representation data, according to one or more embodiments.

FIG. 6 shows a flowchart of a technique for incorporating an eye portion from a reference frame into a live frame, in accordance with one or more embodiments.

FIG. 7 shows an example network diagram for electronic devices participating in an extended reality copresence session, in accordance with one or more embodiments.

FIG. 8 shows, in block diagram form, an exemplary systems for use in various XR technologies, according to one or more embodiments.

### DETAILED DESCRIPTION

This disclosure pertains to systems, methods, and computer-readable media to manage virtual representation data in a shared extended reality environment. In particular, embodiments described herein are directed to techniques for improving security when using user input components in a shared extended reality environment.

For purposes of this description, the term “extended reality” or “XR” refers to a wholly or partially simulated environment.

For purposes of this description, the term “persona” refers to a virtual, photorealistic representation of a subject that is generated to accurately reflect the subject's physical characteristics, movements, and the like based on tracking data of the subject.

For purposes of this description, the term “copresence session” refers to a virtual communication session in which two or more users are active in a common XR environment. In some embodiments, a particular may view other users in the copresence sessions in the form of a persona.

For purposes of this description, the term “live frame” refers to a frame of a virtual representation of a user, or a frame of sensor data used to generate the virtual representation of a user in real or near-real time, for example during a copresence session. Accordingly, the live frame reflects characteristics of the user during capture of the live frame.

For purposes of this description, the term “reference frame” refers to a frame of image data or sensor data captured prior to a live frame. For example, the reference frame may be captured prior to the live frame during the copresence session, offline during an enrollment session, or the like.

Copresence sessions enable users to interact with each other using virtual representations, such as avatars, personas, or photorealistic models, that are generated from local sensor data captured by electronic devices in the form of tracking data. The tracking data can be used to determine visual and geometric characteristics of the user from which the virtual representation of the subject is generated. The virtual representation, or data related to the virtual representation, may be transmitted to other electronic devices participating in the copresence session, such that the subject appears as a virtual representation at the other electronic devices.

In a copresence session, users may generate user input in a number of ways, such as virtual or physical user input components, hand gestures, gaze, and the like. However, some user interactions may involve sensitive information, such as PIN codes, passwords, personal identifying information, or the like. In such cases, the transmission of virtual representation data may expose the user's sensitive information to potential eavesdropping, hacking, or keylogging attacks, when an unauthorized party uses movements of the virtual representation of the user to infer the user's input. Embodiments described herein opportunistically obfuscate tracked user motion such that the user input motions can be hidden from other users in the copresence session, thereby providing additional privacy to a local user.

According to some embodiments, a sensitive input trigger may be detected based on physical and/or virtual input components being present near the user, being interacted with by the user, or the like. In some embodiments, the trigger may be detected based on a combination of an application context and the presence of a user input component, such as if a user prompt is presented for sensitive user information. As another example, a sensitive input trigger may be detected when an input component is detected, or interaction with an input component is detected, which is capable of receiving user input satisfying a sensitivity criterion, such as a predefined classification including personal identifying information, passwords, secure codes, or the like. Examples of user input components may include virtual or physical keyboards, keypads, text fields, or other user interface elements or devices, that are capable of being used by a user to provide sensitive information.

According to one or more embodiments, when a sensitive input component is detected, or a sensitive input trigger is otherwise activated, the transmission of virtual representation data for that user may be adjusted. For example, transmission of virtual representation data may be suspended. In some embodiments, suspending the transmission of virtual representation data may involve suspending capture of sensor data used to generate virtual representation data, such as camera data. For example, one or more cameras may be turned off or inactivated while the sensitive input trigger is active.

In some embodiments, when synchronization of presentation state information is suspended for a local user, additional users may continue to interact with elements in the shared session. The local device may provide an indication that synchronization is suspended, such that the additional devices can indicate to their respective users that the local user is not experiencing the same representation of the multiuser communication session. Additionally, the local user may continue to receive presentation state information from remote users and optionally update the local presentation state while synchronization is suspended.

In some embodiments, the transmission of virtual representation data may be adjusted by generating a modified live frame of virtual representation data that incorporates an eye portion from a reference frame of virtual representation data. In some embodiments, the reference frame may be a frame that is captured or generated during an enrollment process. The eye portion may include a left eye portion and a right eye portion, and may be a single region of the virtual representation of the user, or may include separate regions for a left eye and right eye. The modified live frame may be generated by identifying an eye portion in a live frame of virtual representation data that is captured by a camera or other sensor of the local device. The modified live frame may be generated by incorporating the eye portion from the reference frame into the live frame in accordance with the eye portion in the live frame. For example, the eye portion from the reference frame may be mapped to the eye portion in the live frame based on a head pose or head position of the user in the live frame. The modified live frame may be provided for display at the remote device, such that the eye portion of the user is obfuscated or replaced by the eye portion from the reference frame.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system-and business-related constraints) and that these goals may vary from one implementation to another. It will also be appreciated that such development efforts might be complex and time consuming but would nevertheless be a routine undertaking for those of ordinary skill in the design and implementation of graphics modeling systems having the benefit of this disclosure.

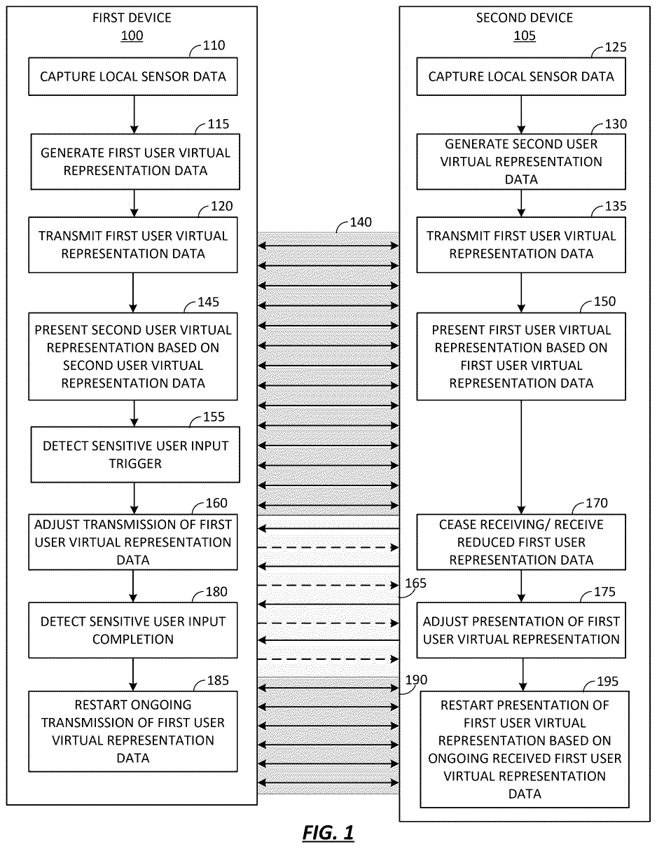

FIG. 1 shows, in flow diagram form, a technique for adjusting transmission of virtual representation data, according to one or more embodiments. In particular, FIG. 1 illustrates an example of a technique adjusting transmission of virtual representation data in response to user interaction with a sensitive input component between a first device 100 and a second device 105, according to one embodiment of the disclosure. Although the flow diagram shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flow diagram begins at block 110, with a first device 100 capturing local sensor data. The local sensor data may be captured by a camera, a microphone, a motion sensor, a gaze tracker, or some combination thereof. The local sensor data may include, but is not limited to, image data, audio data, depth data, motion data, gaze data, or the like. The sensor data may be any data captured by a sensor capturing user characteristics, such as a camera, a microphone, a motion sensor, a gaze tracker, or any other sensor of the local electronic device that captures current characteristics of a user of the electronic device. According to one or more embodiments, the local sensor data captured at block 110 may capture motions or characteristics of a user of the first device 100. To that end, the first device 100 may be a head mounted device or other wearable device, and the local sensor data may be captured by user-facing sensors on the wearable device.

At block 115, a first user virtual representation data is generated by the first device 100 based on the local sensor data collected at block 110. The first user virtual representation may be generated to reflect real world characteristics of the user of the first device 100, such as appearance, motion, geometry or volume, and the like. The first user virtual representation may include, but is not limited to, an avatar, a persona, a photorealistic model, a cartoon, a hologram, or the like. The first user virtual representation may include, but is not limited to, facial features, body features, gestures, expressions, movements, voice, clothing, accessories, or other attributes of the first user. In some embodiments, the first user virtual representation may be a photorealistic model of the user. The first user virtual representation data generated at block 115 may include the virtual representation of the user, or may include data from which a virtual representation of the user can be generated or rendered, such as tracking data, motion data, appearance data, pose information, expression information, or the like. In some embodiments, static and dynamic virtual representation data may be used to generate a virtual representation of a user. For example, tracking data collected during the copresence session may be combined with enrollment data to generate a virtual representation of a user. At block 120, the first device 100 transmits the first user virtual representation data to the second device 105.

Similarly, the second device 105 captures local sensor data at block 125. The local sensor data may be captured by a camera, a microphone, a motion sensor, a gaze tracker, or some combination thereof. The local sensor data may include, but is not limited to, image data, audio data, depth data, motion data, gaze data, or the like. According to one or more embodiments, the local sensor data captured at block 125 may capture motions or characteristics of a user of the second device 105. To that end, the second device 105 may be a head mounted device or other wearable device, and the local sensor data may be captured by user-facing sensors on the wearable device.

At block 130, a second user virtual representation data is generated by the second device 105 based on the local sensor data collected at block 125. The second user virtual representation may be generated to reflect real world characteristics of the user of the second device 105, such as appearance, motion, geometry or volume, and the like. The second user virtual representation may include, but is not limited to, facial features, body features, gestures, expressions, movements, voice, clothing, accessories, or any other suitable attributes of the first user. At block 135, the second device 105 transmits the second user virtual representation data to the first device 100. Thus, as shown in time block 140, the first device 100 and second device 105 continuously provide virtual representation data to each other. This may occur, for example, while the first device 100 and the second device 105 are active in a common copresence session. For example, the first device 100 and the second device 105 may be sharing at least part of an extended reality environment.

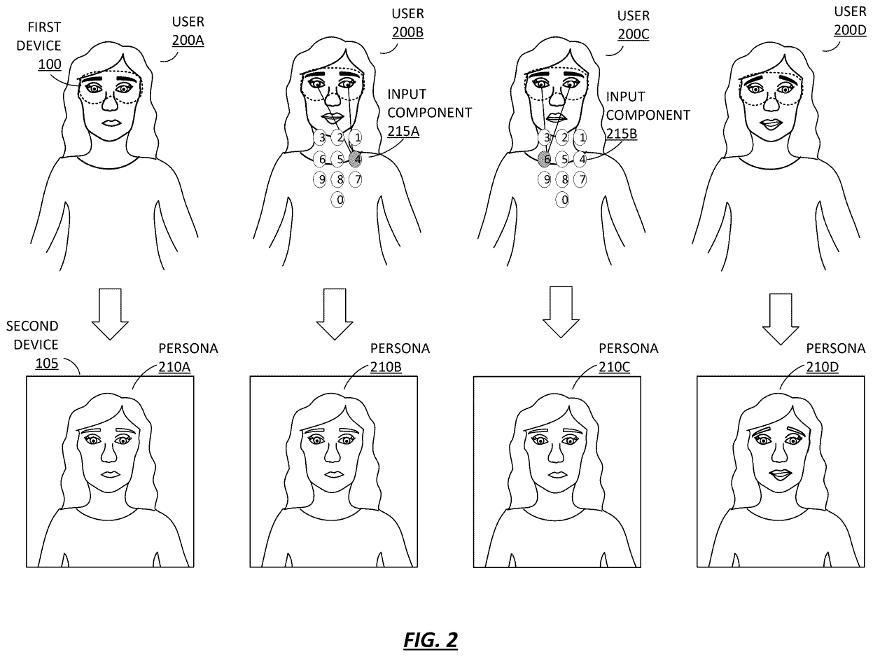

While virtual representation data is shared between the first device 100 and the second device 105 during time block 140, the flowchart includes, at block 145, the first device 100 presenting the second user virtual representation based on the second user virtual representation data received from the second device 105. This may include generating and/or presenting an avatar or persona of the user of the second device to reflect characteristics of the user of the second device during the copresence session. Similarly, at block 150, the second device 105 presenting the first user virtual representation based on the first user virtual representation data received from the first device 100. Turning to FIG. 2, an example is shown where the first device 100 captures sensor data of user 200A to determine current characteristics of the user 200A, and transmits corresponding virtual representation data to the second device 105. The second device 105 then renders a view of the persona 210A which reflects the characteristics of user 200A.

Returning to FIG. 1, the flowchart proceeds to block 155, where the first device 100 detects a sensitive user input trigger. According to some embodiments, the sensitive user input trigger may be detected when a user input component is detected or provided which is capable of being used to provide user input of a predefined sensitivity classification. For example, a sensitivity classification may be applied to input that may include or convey passwords, credit card numbers, personal messages, personal identifying information, health information, or other personal or confidential data. The sensitivity classification may be predefined, may be defined by an application for which a user input component is provided, may be user-defined, or some combination thereof. Sensitive input components may be physical or virtual input components, such as a physical or virtual keyboard, keypad, or the like. Further, the sensitive user input trigger may further be detected based on a context or application state, such as the state of an application running. For example, if a user input field is presented that is tagged as a sensitive field, then a user interacting with a user input component to enter data into the field may be a sensitive user input trigger. In some embodiments, a user interaction may be based on a target of a user's gaze being directed at the input component for a predefined time period, a determination that a user is, or a prediction that a user is about to interact with the input component, for example based on hand proximity or the like, or some combination thereof.

In response to detecting such a trigger, the flow diagram proceeds to block 160, and the first device adjusts the transmission of the first user virtual representation data. Adjusting transmission of the virtual representation data may involve modification of the transmission itself, such as suspending transmission of some or all virtual representation data generated by device 100, or modifying the data to be transmitted. Optionally, as shown at time block 165, adjusting transmission may include ceasing transmission of virtual representation data. That is, the virtual representation data may be generated by the first device 100, but the transmission may be suspended. In some embodiments, adjusting transmission of the virtual representation data may include suspending generation of virtual representation data by the first device 100, or suspending sensor data collection for the user of the first device 100 such that virtual representation data is not generated and, thus, not transmitted to the second device 105. As a result, at block 170, the second device 105 ceases receiving, or receives reduced first user representation data. This is shown at time block 165, where virtual representation data is transmitted by the second device 105 to the first device 100, but is not transmitted from the first device 100 to the second device 105. Alternatively, the second device may receive modified first user representation data. The first user representation data may be modified such that the eye region is modified from the true movements of the first user's eyes.

At block 175, the second device 105 adjusts presentation of the first user virtual representation. For example, at least a portion of the virtual representation may be suspended, or may appear inconsistent with current characteristics of the user of the first device 100. In some embodiments, second device 105 may additionally apply a visual treatment to the first user virtual representation to signal that the first user virtual representation is in a suspended mode, or to obfuscate at least a portion of the virtual representation from which sensitive user input could be derived or inferred, such as eyes, hands, fingers, or the like.

Returning to the example of FIG. 2, user 200B is shown interacting with input component 215 by glancing at a virtual keypad to enter a code. According to one or more embodiments, the interaction with the virtual keypad could satisfy the sensitive user input trigger. Thus, first device 100 may adjust transmission of virtual representation data for the user of the first device 100. Thus, second device 105 shows persona 210B, whose facial expression no longer mirrors the facial expression of the user 200B of the first device 100. This is because the virtual representation data for the user 200B is in a suspended mode at the first device 100. Similarly, as the user 200C continues to use the input component 215B, the persona 210C at the second device 105 remains in a suspended mode. Although not shown, the second device 105 may or may not continue to transmit virtual representation data to the first device 100. Moreover, the first device 100 may or may not present a current virtual representation of the user of the second device while in the suspended mode.

Returning to FIG. 1, a completion of the sensitive user input may be detected by the first device 100, as shown at block 180. This may be determined, for example, when a user ceases interaction with a user input component, for example for a predefined amount of time, or when a sensitive user input component is no longer detected. As another example, the completion of the sensitive user input may be determined when a sensitive input text box is no longer presented. As yet another example, a user can affirmatively indicate that sensitive user input has ceased, for example based on input into a confirmation button, a submission button, a gesture, a voice command, or the like. Further, in some embodiment, a sensitive user input can be determined to be complete based on a timeout.

In response to the determination that the sensitive user input is complete, the flowchart proceeds to block 185, and the first device 100 restarts ongoing transmission of the first user virtual representation data. Restarting the transmission may involve restarting capture of sensor data of a user of the first device 100, and/or generating virtual representation data of the user of the first device 100. Thus, as shown at time block 190, transmission between the first device 100 and the second device 105 resumes such that the second device 105 resumes receiving virtual representation data from the first device 100. Alternatively, restarting ongoing transmission of first user virtual representation data may include adjusting the virtual representation transmitted such that the virtual representation data represents current characteristics of the local user, such as gaze.

The flow diagram ends at block 195, where the second device 105 restarts presentation of the first user virtual representation based on ongoing received first user virtual representation data. That is, the second device 105 resumes presenting a persona or other virtual representation of the user of the first device 100 in a manner that comports to user characteristics during the copresence session. In some embodiment, a transitional effect may be presented when the presentation is restarted. For example, one or more intermediate frames may be generated to transition the suspended persona to the resumed persona.

Returning to the example of FIG. 2, user 200D is no longer interacting with the input component. Thus, the first device 100 can restart transmission of virtual representation data. Accordingly, the second device 105 presents persona 210D, which comports with the appearance of the user 200D and is generated based on virtual representation received from first device 100 capturing sensor data of user 200D.

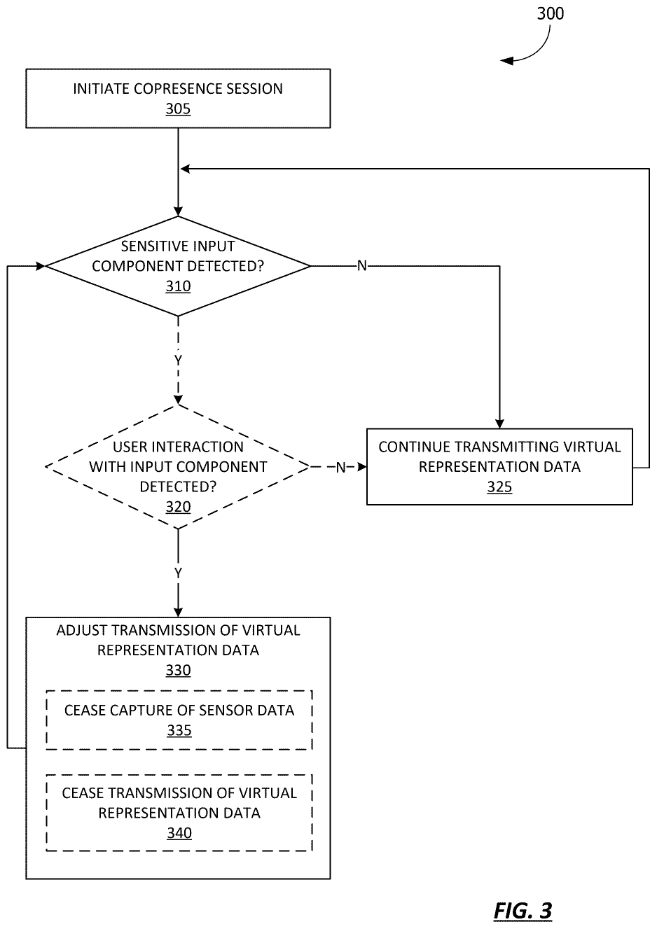

FIG. 3 is a flowchart 300 illustrating an example of a technique for adjusting transmission of virtual representation data in response to user interaction with a sensitive input component, according to one embodiment of the disclosure. It should be understood that the various processes described may be performed in a different order, and some processes may be performed in parallel. Further, according to some embodiments, not all processes may be required. To that end, blocks depicted and/or described as optional merely indicate that some embodiments may involve perform the action described in the block, whereas other embodiments may not.

The flowchart 300 begins at block 305, where a copresence session is initiated. The copresence session may be a virtual communication session in which two or more devices share at least part of a common XR environment. According to some embodiments, the copresence session may include virtual components, such as virtual representations of each of the users. The copresence session may be initiated by a user's electronic device, by a server, or by any other suitable device.

The flowchart proceeds to block 310, where a determination is made as to whether a sensitive input component is detected. According to one or more embodiments, a sensitive input component may be a physical or virtual input component which is capable of being used to provide data that is classified as sensitive data. The determination may be made based on characteristics of the input component, or in combination with other factors such as open windows or other contextual information. The particular parameters used to determine whether an input component is a sensitive input component may be predefined, or may be defined by a particular application such that a same input component may be a sensitive input component when using one application, but may not be a sensitive input component when using another application. Further, the input component may be classified as a sensitive input component based on user-defined parameters or system-defined parameters, or some combination thereof.

If a sensitive input component is detected at block 310 then, optionally, the flowchart 300 proceeds to decision block 320, and a determination is made as to whether a user interaction is detected with the sensitive user input component. The user interaction may be an action performed by a user to use the sensitive input component to generate user input. In some embodiment, the user interaction may be an observed or detected user interaction, for example based on image data or other sensor data, based on input received by the input device, or the like. In some embodiments, the user interaction may be a predicted user interaction based on tracking data for the user. As an example, if a user or a user's hand or hands are within a predefined distance and/or moving toward the sensitive user input component, then user interaction may be detected. If a user interaction is not detected at block 320 or, returning to block 310, if no sensitive input component is detected, then the flowchart proceeds to block 325, and the local device continues transmitting virtual representation data. As described above, this may include capturing tracking data of a local user, using the tracking data to generate virtual representation data for the local user, and transmitting the virtual representation data to another device active in the copresence session. The virtual representation data may include data from which a virtual representation of a user is generated or rendered.

Returning to block 310, if a sensitive input is detected and, optionally, at block 320, a user interaction is detected with the input component, then the flowchart 300 proceeds to block 330. At block 330, the transmission of virtual representation data is adjusted by the local device. Adjusting transmission data may involve modification of the transmission itself, such as suspending transmission, or modification of the data to be transmitted. Optionally, as shown at block 335, adjusting transmission of virtual representation data may include ceasing capture of sensor data. The sensor data may be any data captured by a camera, a microphone, a motion sensor, a gaze tracker, or any other sensor of the local electronic device that captures current characteristics of a user of the electronic device. Additionally, optionally, as shown at block 340, adjusting transmission of the virtual representation may involve ceasing transmission of virtual representation data. That is, the virtual representation data may be generated by the local device, but the transmission may be suspended.

The transmission of virtual representation data may be adjusted for a predefined time period, until the user interaction is completed, until a user input is confirmed, or based on another criterion or combination thereof. In one example, as shown by flowchart 300, a determination may be made as to whether the sensitive input component remains detected at block 310, and the flowchart may continue with the adjusted transmission of virtual representation data until the sensitive input component is no longer detected at block 310 or, optionally, user interaction with the sensitive input component is no longer detected at block 320. Then the flowchart 300 concludes at block 325 and the virtual representation data is transmitted without the adjustment.

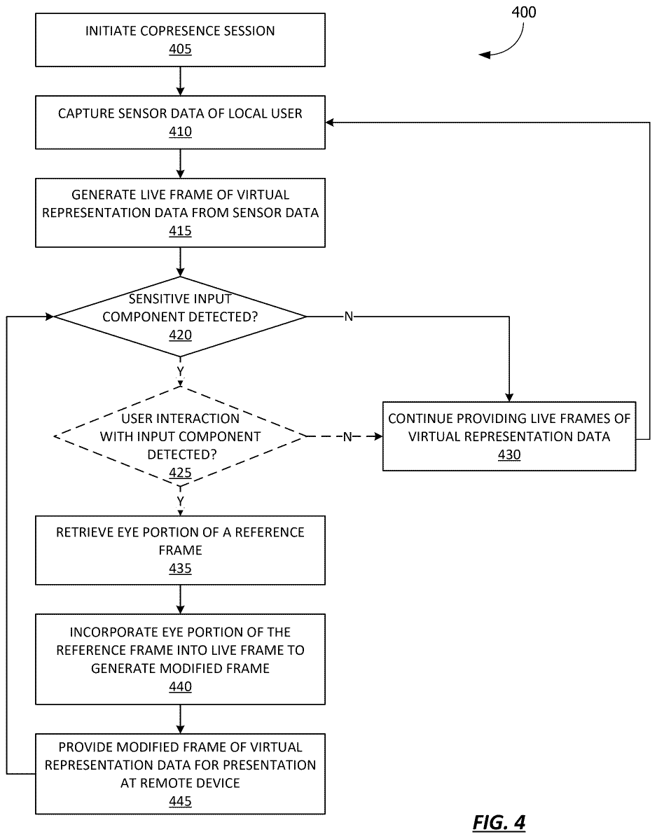

According to some embodiments, adjusting the transmission of virtual representation data may involve modifying a live frame of virtual representation data to obfuscate at least part of the user, such as the eyes, mouth, or the like. FIG. 4 illustrates an example of a technique for adjusting transmission of virtual representation data in response to user interaction with a sensitive input component, according to one embodiment of the disclosure. It should be understood that the various processes described may be performed in a different order, and some processes may be performed in parallel. Further, according to some embodiments, not all processes may be required.

The flowchart 400 begins at block 405, where a copresence session is initiated. The copresence session may be a virtual communication session in which two or more devices share at least part of a common XR environment. According to some embodiments, the copresence session may include virtual components, such as virtual representations of each of the users. The copresence session may be initiated by a user's electronic device, by a server, or by any other suitable device.

The flowchart 400 proceeds to block 410, where sensor data of a local user is captured. The sensor data may include any data captured by sensors such as cameras, microphones, motion sensors, gaze trackers, or any other sensors of an electronic device that capture current characteristics of a user. This data can include image data, audio data, depth data, motion data, gaze data, or similar types of information which can be used to generate a virtual representation of a user. At block 415, a live frame of virtual representation data is generated from the sensor data. The live frame may include, for example, sensor data from which a virtual representation of the user may be generated, reflecting current visual characteristics of the user being tracked. For example, the live frame may include 2D or 3D representation data for the user, such as geometry data, texture data, image data, or other data from which a virtual representation can be generated, for example in the form of a persona.

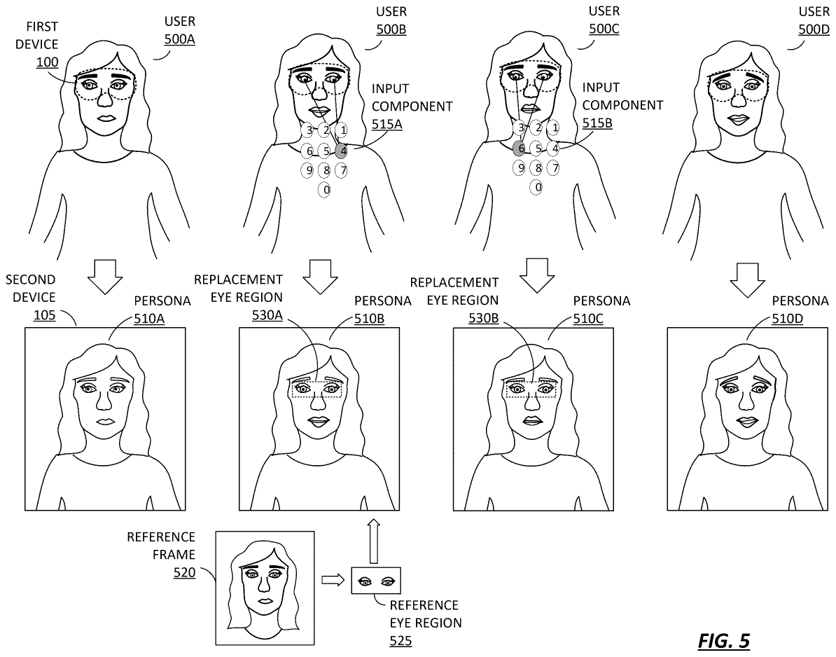

Turning to FIG. 5, an example is shown where the first device 100 captures sensor data of user 500A to determine current characteristics of the user 500A, and transmits corresponding virtual representation data to the second device 105. The second device 105 then renders a view of the persona 510A which reflects the characteristics of user 500A. Thus, the live data is represented as persona 510A at second device 105.

Returning to FIG. 4, the flowchart 400 proceeds to block 420, where a determination is made as to whether a sensitive input component is detected. According to one or more embodiments, a sensitive input component may be a physical or virtual input component which is capable of being used to provide data that is classified as sensitive data. The determination may be made based on characteristics of the input component, or in combination with other factors such as open windows or other contextual information. The particular parameters used to determine whether an input component is a sensitive input component may be predefined, or may be defined by a particular application such that a same input component may be a sensitive input component when using one application, but may not be a sensitive input component when using another application. Further, the input component may be classified as a sensitive input component based on user-defined parameters or system-defined parameters, or some combination thereof.

If a sensitive input component is detected at block 410 then, optionally, the flowchart 400 proceeds to decision block 425, and a determination is made as to whether a user interaction is detected with the sensitive user input component. The user interaction may be an action performed by a user to use the sensitive input component to generate user input. In some embodiment, the user interaction may be an observed or detected user interaction, for example based on image data or other sensor data, based on input received by the input device, or the like. In some embodiments, the user interaction may be a predicted user interaction based on tracking data for the user. As an example, if a user or a user's hand or hands are within a predefined distance and/or moving toward the sensitive user input component, then user interaction may be detected. If a user interaction is not detected at block 425 or, returning to block 420, if no sensitive input component is detected, then the flowchart 400 proceeds to block 430, and the local device continues transmitting virtual representation data. As described above, this may include capturing tracking data of a local user, using the tracking data to generate virtual representation data for the local user, and transmitting the virtual representation data to another device active in the copresence session. The virtual representation data may include data from which a virtual representation of a user is generated or rendered.

Returning to block 420, if a sensitive input is detected and, optionally, at block 425, a user interaction is detected with the input component, then the flowchart 400 proceeds to block 435. At block 435, an eye portion of a reference frame is retrieved. According to one or more embodiments, the reference frame may be a frame of a virtual representation of the user captured prior to a current live frame. In some embodiments, the reference frame may include just an eye region, or may contain more of a face, from which the eye region can be retrieved. In some embodiments, the eye portion of the reference frame may be predefined, and may be generated and stored prior to the copresence session. For example, during an enrollment period, a local user can use their device to capture sensor data of their face in order to generate persona data used to drive the virtual representation during the copresence session. The eye portion may be a single continuous region of a face containing both eyes, or may include separate eye regions, such as a combination of the portions of the virtual representation data corresponding to the eyes, eyeballs, pupil and iris, or the like.

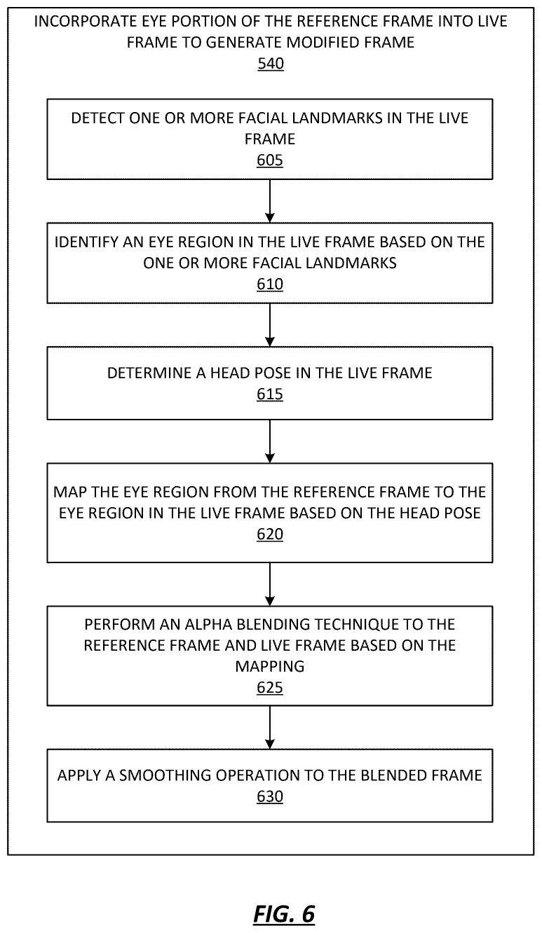

The flowchart 400 proceeds to block 440, where the eye portion of the reference frame is incorporated into the live frame to generate a modified frame. The eye portion can be incorporated in a variety of ways. For example, an eye region of the live frame can be extracted and replaced by the reference eye region. As another example, a composite frame can be generated by increasing a transparency of the eye region in the live frame and overlaying the reference eye portion such that the eye region in the live frame is not visible in the adjusted frame. In some embodiments, the reference eye region and the live frame eye region can be aligned, for example, based on head pose data such as head position, eye tracking data, or the like. Various techniques for incorporating the reference eye portion into the live frame will be described in greater detail below with respect to FIG. 6.

The flowchart 400 proceeds to block 445, where the modified frame of the virtual representation of the local user is provided for presentation at a remote device. As described above, the modified frame may include data from which a 3D representation of the user can be generated and/or presented. The modified frame may be transmitted to the second device, and/or may be made available for additional devices in a copresence session.

Returning to the example of FIG. 5, user 500B is shown interacting with input component 515A by glancing at a virtual keypad to enter a code. According to one or more embodiments, the interaction with the virtual keypad could satisfy the sensitive user input trigger. Thus, first device 100 may adjust transmission of virtual representation data for the user 400B of the first device 100. In particular, a reference eye region 525 can be obtained, for example, from a reference frame 520. In some embodiments, the reference eye region 525 can be extracted from the reference frame 520 during runtime. Alternatively, the reference eye region 525 may be previously extracted and stored, such as during an enrollment process of user 500. Device 100 may replace an eye region with replacement eye region 530A to generate persona 510B. As a result, the replacement eye region 530A is presented to the user in a way such that the real gaze direction of user 500B is obfuscated. Thus, second device 105 shows persona 510B, whose eyes no longer mirrors the eyes of the user 500B of the first device 100, although other characteristics of the user may be presented in a consistent manner, such as head direction, mouth movements, or the like In this case, the eyebrows of persona 510B are shown to mirror the eyebrows of user 400B, although the gaze direction differs. Similarly, as the user 500C continues to use the input component 515B, the persona 510C at the second device 105 continues to reflect the reference eye region 525 as replacement eye region 530B, while other characteristics of persona 410C, such as eyebrows, lips, and the like, continue to mirror the movements of user 400C.

The transmission of virtual representation data may be adjusted for a predefined time period, until the user interaction is completed, until a user input is confirmed, or based on another criterion or combination thereof. In one example, as shown by flowchart 400, a determination may be made as to whether the sensitive input component remains detected at block 420, and the flowchart may continue with the adjusted transmission of virtual representation data until the sensitive input component is no longer detected at block 420 or, optionally, user interaction with the sensitive input component is no longer detected at block 425. Then the flowchart 400 concludes at block 430 and the live frames of virtual representation data are provided without the adjustment.

Returning to the example of FIG. 5, user 500D is no longer interacting with the input component. Thus, the first device 100 can restart transmission of virtual representation data. Accordingly, the second device 505 presents persona 510D, in a manner which comports with the appearance of the user 500D and is generated based on virtual representation received from first device 100 capturing sensor data of user 500D. In particular, an eye region of persona 410D now mirrors the eye region of user 400D.

FIG. 6 is a flowchart illustrating an example of a technique for generating a modified live frame of virtual representation data for a user in response to detecting user interaction with a sensitive input component, according to some embodiments. In particular, the technique described with respect to FIG. 6 is directed to techniques for incorporating a reference eye portion into a live frame to generate a modified frame, as described above generally with respect to block 540 of FIG. 5. It should be understood that the various processes described may be performed in a different order, and some processes may be performed in parallel. Further, according to some embodiments, not all processes may be required.

The flowchart begins at block 605, where the electronic device detects one or more facial landmarks in the live frame of virtual representation data. The live frame of virtual representation data may be generated from sensor data capturing the user, such as image data, depth data, motion data, gaze data, or the like. Accordingly, the live frame may include a visual representation of the user. The facial landmarks may include, but are not limited to, points or regions corresponding to the user's eyes, nose, mouth, eyebrows, chin, or other facial features, and may be detected in two or three dimensions. The detection of the facial landmarks may be performed by using any suitable computer vision techniques, such as face detection, face alignment, face recognition, feature detection, and the like.

At block 610, the electronic device identifies an eye region in the live frame based on the one or more facial landmarks. The eye region may include, for example, a portion of the live frame that includes the user's left eye, right eye, or both eyes. The identification of the eye region may be performed by using any suitable geometric or spatial techniques, such as bounding boxes, contours, masks, or the like. In some embodiments, the eye region may be a continuous region, or may be comprised of multiple distinct regions, such as a left eye portion and a right eye portion. In some embodiments, the region may include the eyeball, the iris and pupil, or the like. Further, in some embodiments, the eye region may be defined to exclude an eyelid, such that the eyelid of the virtual representation remains consistent with the live frames.

The flowchart continues at block 615, where the electronic device determines a head pose in the live frame. The head pose may include, but is not limited to, the orientation, rotation, or position of the user's head in the live frame. The determination of the head pose may be performed based on sensor data such as image data, for example using visual inertial techniques, and/or motion data, such as data captured by an accelerometer, IMU, or the like.

At block 620, the electronic device maps the eye region from the reference frame of virtual representation data to the eye region in the live frame based on the head pose. The reference frame of virtual representation data may be obtained during an enrollment process at the electronic device, and, in some embodiments, may include data from which a neutral or resting expression of the user is generated or rendered. Alternatively, the reference frame may be any prior frame of virtual representation data and may include at least an eye region. The mapping may include, but is not limited to, aligning, transforming, warping, or projecting the eye region from the reference frame to the eye region in the live frame, such that the eye region in the reference frame matches the eye region in the live frame in terms of size, shape, location, orientation, or the like.

The flowchart proceeds to block 625, where the electronic device performs an alpha blending technique to the reference frame eye region and the live frame based on the mapping. The alpha blending technique may include, but is not limited to, combining the pixel values of the eye region in the neutral reference frame and the eye region in the live frame using a weighted average, such that the appearance of the eye region in the live frame is reduced and the appearance of the eye region in the neutral reference frame is increased.

The flowchart concludes at block 630, where the electronic device applies a smoothing operation to the blended frame. The smoothing operation may include, but is not limited to, reducing the noise, artifacts, or discontinuities in the blended frame, such that the transition between the eye region in the neutral reference frame and the rest of the live frame is smooth and natural. The smoothing operation may be performed by using any suitable image processing techniques, such as filtering, blurring, interpolation, or the like.

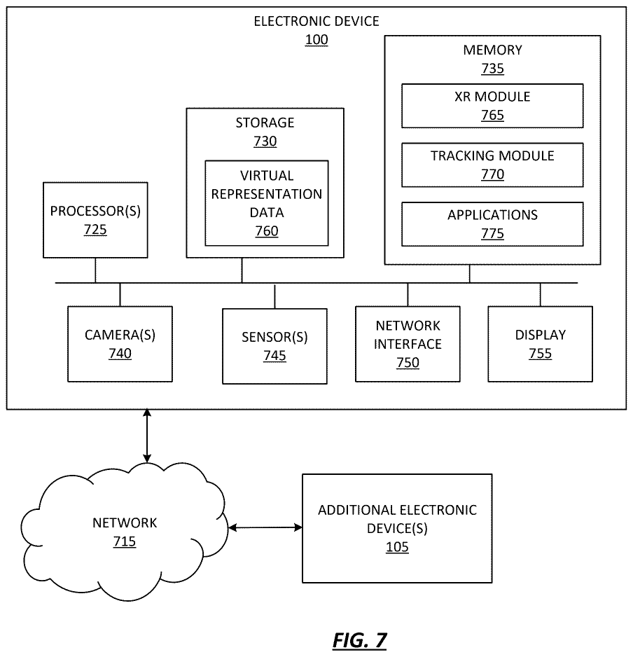

Referring to FIG. 7, a simplified block diagram of an electronic device 100 is depicted, communicably connected to additional electronic devices 105 over a network 715, in accordance with one or more embodiments of the disclosure. Electronic device 100 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 100, additional electronic device(s) 105, and/or network storage may additionally, or alternatively, include one or more additional devices within which the various functionality may be contained or across which the various functionality may be distributed, such as server devices, base stations, accessory devices, and the like. Illustrative networks, such as network 715 include, but are not limited to, a local network such as a universal serial bus (USB) network, an organization's local area network, and a wide area network such as the Internet. According to one or more embodiments, electronic device 100 is utilized to participate in a multiuser communication session in an XR environment, such as a copresence session. It should be understood that the various components and functionality within electronic device 100, additional electronic device 105 and network storage may be differently distributed across the devices or may be distributed across additional devices.

Electronic device 100 may include one or more processors 725, such as a central processing unit (CPU). Processor(s) 725 may include a system-on-chip such as those found in mobile devices and include one or more dedicated graphics processing units (GPUs). Further, processor(s) 725 may include multiple processors of the same or different type. Electronic device 100 may also include a memory 735. Memory 735 may include one or more different types of memory, which may be used for performing device functions in conjunction with processor(s) 725. For example, memory 735 may include cache, ROM, RAM, or any kind of transitory or non-transitory computer-readable storage medium capable of storing computer-readable code. Memory 735 may store various programming modules for execution by processor(s) 725, including XR module 765, tracking module 770, and other various applications 775. Electronic device 100 may also include storage 730. Storage 730 may include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 730 may be configured to store virtual representation data 760, according to one or more embodiments. Electronic device 100 may additionally include network interface 750, from which additional network components may be accessed via network 715.

Electronic device 100 may also include one or more cameras 740 or other sensors 745, such as a depth sensor, from which depth or other characteristics of an environment may be determined. In one or more embodiments, each of the one or more cameras 740 may be a traditional RGB camera or a depth camera. Further, cameras 740 may include a stereo camera or other multicamera system, a time-of-flight camera system, or the like. Cameras 740 may include one or more user-facing cameras, one or more scene-facing cameras, or some combination thereof.

Electronic device 100 may also include a display 755. The display device 755 may utilize digital light projection, OLEDs, LEDs, uLEDs, liquid crystal on silicon, laser scanning light source, or any combination of these technologies. Display device 755 may be utilized to present a representation of a multiuser communication session, including shared virtual elements within the multiuser communication session and other XR objects. Display 755 may have an opaque, or a transparent or translucent display. The transparent or translucent display can have a medium through which light is directed to a user's eyes. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

Storage 730 may be utilized to store various data and structures which may be utilized for providing state information in order to track an application state and session state. Storage 730 may include, for example, virtual representation data store 760. Virtual representation data store 760 may be utilized to store information to be used to generate virtual representations of a local user, such as static virtual representation data generated during an enrollment period, user-specific models, or the like.

According to one or more embodiments, memory 735 may include one or more modules that comprise computer-readable code executable by the processor(s) 725 to perform functions. The memory may include, for example, tracking module 770, which is configured to determine characteristics of a local user from sensor data captured by the electronic device 100, such as camera(s) 740, sensor(s) 745, or the like. Memory 735 may also include an XR module 765 which may be used to provide a copresence session in an XR environment. In some embodiments, the XR module 765 may generate a virtual representation of a local user, for example using the tracking data from tracking module 770, and data from virtual representation data 760.

In some embodiments, the virtual representation data may be suspended or the transmission of the virtual representation data may be adjusted based on detected sensitive input components, such as virtual input components associated with applications 775, and/or physical components detected, for example, by camera(s) 740, or other signals transmitted to or received by the electronic device 100. The virtual representation data may be transmitted to additional electronic device(s) 105 such that the additional electronic device(s) 105 can use the virtual representation data to present a virtual representation of a user of the electronic device 100.

Although electronic device 100 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, or some combination of the functionality of any of the components may be combined.

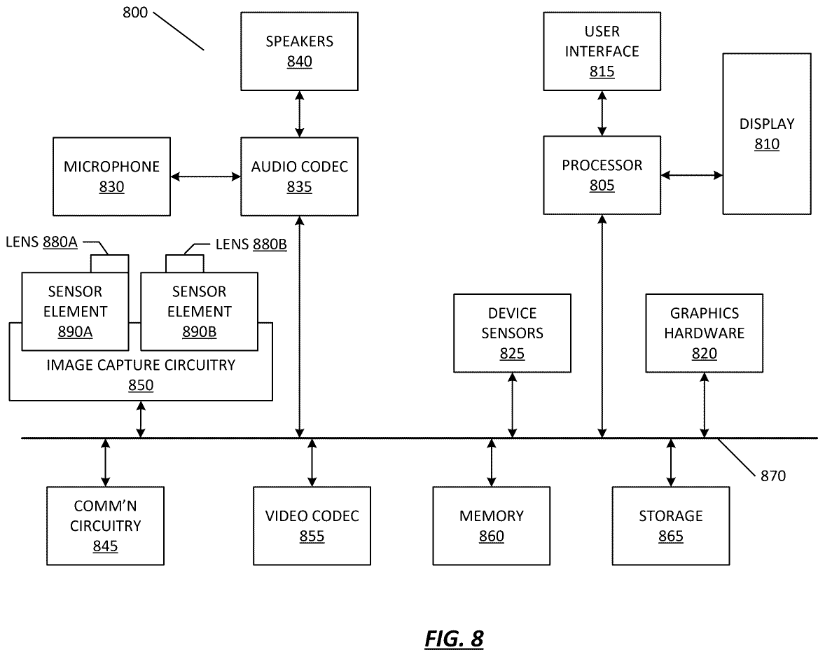

Referring now to FIG. 8, a simplified functional block diagram of illustrative multifunction electronic device 800 is shown according to one embodiment. Each of electronic devices may be a multifunctional electronic device, or may have some or all of the described components of a multifunctional electronic device described herein. Multifunction electronic device 800 may include some combination of processor 805, display 810, user interface 815, graphics hardware 820, device sensors 825 (e.g., proximity sensor/ambient light sensor, accelerometer and/or gyroscope), microphone 830, audio codec 835, speaker(s) 840, communications circuitry 845, digital image capture circuitry 850 (e.g., including camera system), memory 860, storage device 865, and communications bus 870. Multifunction electronic device 800 may be, for example, a mobile telephone, personal music player, wearable device, tablet computer, and the like.

Processor 805 may execute instructions necessary to carry out or control the operation of many functions performed by device 800. Processor 805 may, for instance, drive display 810 and receive user input from user interface 815. User interface 815 may allow a user to interact with device 800. For example, user interface 815 can take a variety of forms, such as a button, keypad, dial, a click wheel, keyboard, display screen, touch screen, and the like. Processor 805 may also, be a system-on-chip such as those found in mobile devices and include a dedicated graphics processing unit (GPU). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 to process graphics information. In one embodiment, graphics hardware 820 may include a programmable GPU.

Image capture circuitry 850 may include one or more lens assemblies, such as 880A and 880B. The lens assemblies may have a combination of various characteristics, such as differing focal length and the like. For example, lens assembly 880A may have a short focal length relative to the focal length of lens assembly 880B. Each lens assembly may have a separate associated sensor element 890. Alternatively, two or more lens assemblies may share a common sensor element. Image capture circuitry 850 may capture still images, video images, enhanced images, and the like. Output from image capture circuitry 850 may be processed, at least in part, by video codec(s) 855 and/or processor 805 and/or graphics hardware 820, and/or a dedicated image processing unit or pipeline incorporated within circuitry 845. Images so captured may be stored in memory 860 and/or storage 865.

Memory 860 may include one or more different types of media used by processor 805 and graphics hardware 820 to perform device functions. For example, memory 860 may include memory cache, read-only memory (ROM), and/or random-access memory (RAM). Storage 865 may store media (e.g., audio, image, and video files), computer program instructions or software, preference information, device profile information, and any other suitable data. Storage 865 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to tangibly retain computer program instructions or computer readable code organized into one or more modules and written in any desired computer programming language. When executed by, for example, processor 805 such computer program code may implement one or more of the methods described herein.

A person can interact with and/or sense a physical environment or physical world without the aid of an electronic device. A physical environment can include physical features, such as a physical object or surface. An example of a physical environment is a physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples includes heads-up displays (HUDs), head-mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head-mountable system can have one or more speaker(s) and an opaque display. Other head-mountable systems can be configured to accept an opaque external display (e.g., a smartphone). The head-mountable system can include one or more image sensors to capture images/video of the physical environment and/or one or more microphones to capture audio of the physical environment. A head-mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

The techniques defined herein consider the option of obtaining and utilizing a user's personal information. For example, such personal information may be provided during a multi-user communication session on an electronic device. However, to the extent such personal information is collected, such information should be obtained with the user's informed consent, such that the user has knowledge of and control over the use of their personal information.

Parties having access to personal information will utilize the information only for legitimate and reasonable purposes, and will adhere to privacy policies and practices that are at least in accordance with appropriate laws and regulations. In addition, such policies are to be well-established, user-accessible, and recognized as meeting or exceeding governmental/industry standards. Moreover, the personal information will not be distributed, sold, or otherwise shared outside of any reasonable and legitimate purposes.

Users may, however, limit the degree to which such parties may obtain personal information. The processes and devices described herein may allow settings or other preferences to be altered such that users control access of their personal information. Furthermore, while some features defined herein are described in the context of using personal information, various aspects of these features can be implemented without the need to use such information. As an example, a user's personal information may be obscured or otherwise generalized such that the information does not identify the specific user from which the information was obtained.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1-6 or the arrangement of elements shown in FIGS. 7-8 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain English equivalents of the respective terms “comprising” and “wherein.”

1. A method comprising:
detecting user interaction with a sensitive input component by a first user at a first device; and
in response to detecting the user interaction with the sensitive input component, adjusting transmission of virtual representation data corresponding to the first user to a second device,
wherein the first device and the second device are active in a virtual communication session.

2. The method of claim 1, further comprising:
determining that an input component is a sensitive input component based on a predefined classification of the input component by a corresponding application.

3. The method of claim 1, further comprising:
determining that an input component is a sensitive input component based on an application state of a corresponding application.

4. The method of claim 1, wherein the sensitive input component comprises a virtual input component.

5. The method of claim 1, wherein the sensitive input component comprises a physical input component.

6. The method of claim 5, wherein detecting the user interaction comprises:
determining a gaze of the first user targets the sensitive input component for a predefined time period.

7. The method of claim 6, wherein detecting the user interaction further comprises:
determining that a user interacts with the sensitive input component to generate user input.

8. A non-transitory computer readable medium comprising computer readable code executable by one or more processors to:
detect user interaction with a sensitive input component by a first user at a first device; and
in response to detecting the user interaction with the sensitive input component, adjust transmission of virtual representation data corresponding to the first user to a second device,
wherein the first device and the second device are active in a virtual communication session.

9. The non-transitory computer readable medium of claim 8, further comprising computer readable code to:
determine that an input component is a sensitive input component based on a predefined classification of the input component by a corresponding application.

10. The non-transitory computer readable medium of claim 8, further comprising computer readable code to:
determine that an input component is a sensitive input component based on an application state of a corresponding application.

11. The non-transitory computer readable medium of claim 8, wherein the sensitive input component comprises a virtual input component.

12. The non-transitory computer readable medium of claim 8, wherein the computer readable code to adjust transmission of the virtual representation data further comprises computer readable code to:
suspend capture of camera data from which the virtual representation data is generated.

13. The non-transitory computer readable medium of claim 8, wherein the computer readable code to adjust transmission further comprises computer readable code to:
suspend transmission of at least a portion of the virtual representation data.

14. The non-transitory computer readable medium of claim 8, wherein the virtual representation data comprises data from which a photorealistic representation of the first user is generated.

15. A system comprising:
one or more processors; and
one or more computer readable media comprising computer readable code executable by the one or more processors to:
detect user interaction with a sensitive input component by a first user at a first device; and
in response to detecting the user interaction with the sensitive input component, adjust transmission of virtual representation data corresponding to the first user to a second device,
wherein the first device and the second device are active in a virtual communication session.

16. The system of claim 15, further comprising computer readable code to:
determine that an input component is a sensitive input component based on a predefined classification of the input component by a corresponding application.

17. The system of claim 15, further comprising computer readable code to:
determine that an input component is a sensitive input component based on an application state of a corresponding application.

18. The system of claim 15, wherein the sensitive input component comprises a virtual input component.

19. The system of claim 15, wherein the sensitive input component comprises a physical input component.

20. The system of claim 15, wherein the computer readable code to adjust transmission of the virtual representation data further comprises computer readable code to:
suspend capture of camera data from which the virtual representation data is generated.
